(19) United States
(12) Patent Application Publication
(10) Pub. No.: US 2016/0063408 A1
(43) Pub. Date: Mar. 3, 2016

(54) Method and system for an organizational survey

(71) Applicant: HCL Technologies Limited, Noida (IN)

(72) Inventors: Anand Rajaganesan, NOIDA (IN); Sandeep Samuel Verghese, NEW DELHI (IN); SHIVANI VOHRA, NEW DELHI (IN)

(21) Appl. No.: 14/474,196

(22) Filed: Sep. 1, 2014

(51) Int. Cl. G06Q 10/06; H04L 29/08

(52) U.S. Cl. CPC G06Q 10/0639; H04L 67/10

(57) ABSTRACT

Embodiments herein disclose a method and system for enabling an automated survey platform to capture feedback based on at least one survey, which may be used towards individual and organizational development. Embodiments herein disclose a method and system for enabling an automated survey platform, which integrates multiple survey platforms (which may be based on a plurality of differing technologies) into a single platform. Embodiments herein disclose a method and system for enabling an automated survey platform, which may be trigger based; wherein the trigger may be a date based trigger or an event based trigger. Embodiments herein disclose a method and system for enabling an automated survey platform, which will generate at least one report based on the received response to a survey. Embodiments herein disclose a method and system for enabling an automated survey platform, which may offer at least one post assessment intervention means.

### TECHNICAL FIELD

Embodiments herein relate to an automated platform for performing surveys in an organization and more particularly to an automated platform for performing surveys in an organization, wherein the platform is an integration of multiple survey platforms present in the organization.

### BACKGROUND

Feedback from employees in an organization plays a vital role in the organization. Such a feedback process often comprises of the employees filling a plurality of feedback modes such as surveys, forms, questionnaires and so on. These feedback modes may be for determining the environment in the organization, the strengths and development areas of peers, individual passion areas, employee satisfaction and so on. These feedback modes may be executed at varying frequencies (which may be time based and/or event based) depending on the nature and objectives of the feedback modes.

However, most organizations may have multiple feedback modes running through the organization throughout the year at varied times. Since these feedback modes may run in different time windows, the data received from the feedback modes may or may not have be currently relevant and therefore validity of such delayed data may be less accurate.

Also, due to the multiple numbers of surveys that an employee is required to complete, the time and effort required from the employees is also much higher. Also, each survey is being handled independently in different platforms and/or teams, resulting in to sub optimal use of bandwidth and resources.

With integration under a single platform, inter-tool linkages are now possible so that even at an output level the various tools can speak to each other to provide a holistic view of the organization/individual. This feature was not available before the integration into the platform.

Also, a lack of linkage between metric design and business outcome is also noticed. Also, employees have limited line of sight on actions taken in response to their provided feedback modes and what progress has been made based on the actions. Further, there is a lack of flexibility whereby a manager in the organization is unable to initiate specific targeted surveys.

Existing solutions are pre-configured and typically do not consider the profile of the employee i.e. survey is configured based on role and life event of the employee. Also, existing solutions do not use information available on social platforms. Also, existing solutions use pre-defined thresholds for performing the analysis on responses, wherein the thresholds are not automatically configurable based on the responses. Existing systems do not consider if an employee has already been surveyed within a very short time period, before sending the survey to the employees.

### BRIEF DESCRIPTION OF THE FIGURES

The embodiments herein will be better understood from the following detailed description with reference to the drawings, in which:

FIG. 1 illustrates a system for performing surveys in an organization, according to embodiments as disclosed herein;

FIG. 2 illustrates a survey manager configured for performing surveys in an organization, according to embodiments as disclosed herein;

FIG. 3 illustrates a survey manager configured for performing surveys in an organization, according to embodiments as disclosed herein; and

FIGS. 4a and 4b are flowcharts illustrating the process of performing surveys in an organization, according to embodiments as disclosed herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

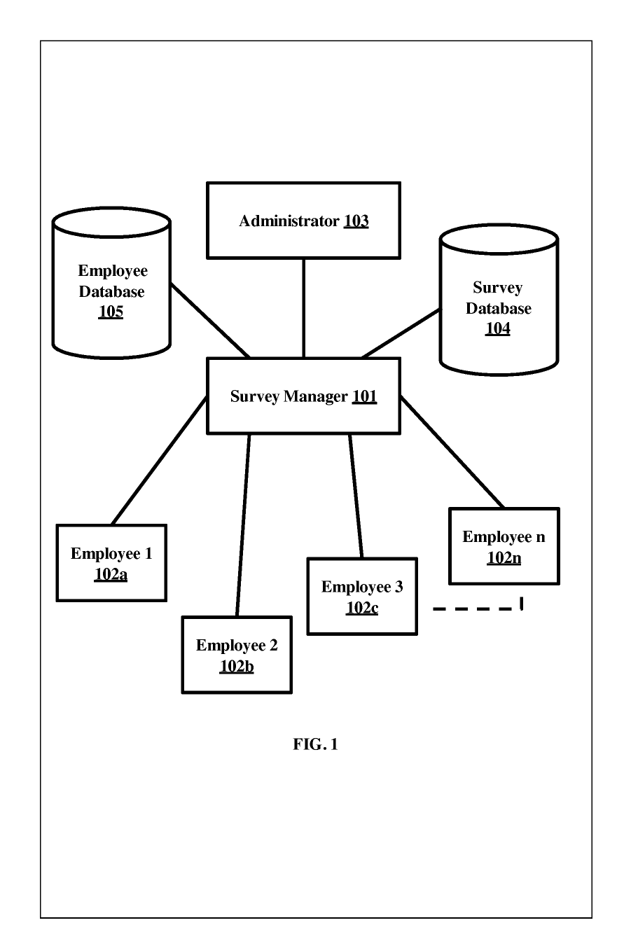

The embodiments herein disclose an automated platform for performing surveys in an organization, wherein the platform is an integration of multiple survey platforms present in the organization. Referring now to the drawings, and more particularly to FIGS. 1 through 4, where similar reference characters denote corresponding features consistently throughout the figures, there are shown embodiments.

Embodiments herein disclose a method and system for enabling an automated survey platform to capture (give and receive) feedback based on at least one survey, which may be used towards individual and organizational development.

Embodiments herein disclose a method and system for enabling an automated survey platform, which integrates multiple independent survey platforms (which may be based on a plurality of differing technologies) into a single platform.

Embodiments herein disclose a method and system for enabling an automated survey platform, which may be trigger based; wherein the trigger may be a date based trigger or an event based trigger.

Embodiments herein disclose a method and system for enabling an automated survey platform, which will generate at least one report based on the received response to a survey.

Embodiments herein disclose a method and system for enabling an automated survey platform, which may offer at least one post assessment intervention means.

FIG. 1 illustrates a system for performing surveys in an organization, according to embodiments as disclosed herein. The system, as depicted, comprises of a survey manager 101. The survey manager 101 may be connected to at least one employee 102. The survey manager 101 may be connected to the employees 102 using a suitable connection means such as internet, a Local Area Network (LAN), a Wide Area Network (WAN), a Virtual Private Network (VPN) and so on. The employees may be an employee of the organization, a contractor who is a part of the organization, the head of the organization or any other person who may be involved with the organization. At least one of the employees may have rights to access survey, summary reports and associated analysis of at least one other employee. In an example, a manager may have access to survey and associated analysis of employees who report to the manager. In another example, the head(s) of the organization (such as a Chief Executive Officer, Chief Operating Office and so on) may have access to survey and associated analysis of all the employees in the organization. In another example, the employee may have access to survey and associated analysis of employees who work with him and the manager(s) to whom he reports, wherein the employee may view at least one portion of the reports generated by at least one survey related to the employee.

The survey manager 101 may enable an administrator 103 to administer the survey. The survey manager 101 may be connected to the administrator 103 using a suitable connection means such as internet, a Local Area Network (LAN), a Wide Area Network (WAN), a Virtual Private Network (VPN) and so on. The administrator 103 may be a person from the organization, who is authorized to administer the survey. The administrator 103 may change triggers, the survey, information related to the employees and so on. The administrator 103 may set up automatic triggers, wherein the survey manager 101 automatically make at least one survey available to the employees, based on the triggers, The administrator 103 may also upload, create and execute surveys manually.

The survey manager 101 may be connected to at least one database. The survey manager 101 may be connected to the database 104, 105 using a suitable connection means such as internet, a Local Area Network (LAN), a Wide Area Network (WAN), a Virtual Private Network (VPN) and so on. The database may be a survey database 104, wherein the survey database 104 may comprise of statements which have to be taken by the employees and so on. The statements may comprise of self-appraisal statements (comprising of queries pertaining to self-strengths, development areas and passion areas of the employees), employee statements (comprising of queries related to feedback about reporting manager, other employees and so on) and work environment statements (comprising of queries related to the work environment, human resource policies, culture of the organization and so on). The survey database 104 may comprise of at least one trigger associated with each statement. In an embodiment herein, the survey database 104 may comprise of at least one database, wherein the statements may be distributed over more than one database. In an embodiment, the survey database 104 may be on the cloud. The database may be an employee database 205. The employee database 205 may comprise of information related to employees of the organization, wherein the information may comprise of surveys taken by the employees, the responses to the statements, the dates at which the surveys were taken, other employees who may access the surveys and associated results of the employee and the extent to which the other employees may view the surveys and associated results, milestones associated with the employee and so on. In an embodiment herein, the employee database 105 may comprise of at least one database, wherein the employee information may be distributed over more than one database. In an embodiment, the employee database 105 may be on the cloud or on a server belonging to the organization.

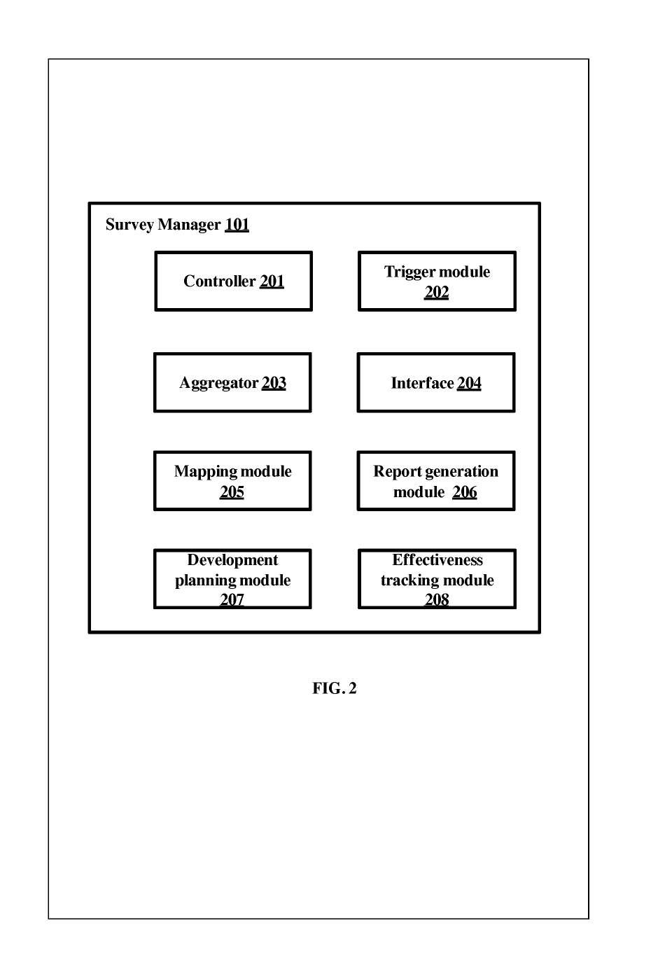

FIG. 2 illustrates a survey manager configured for performing reviews in an organization, according to embodiments as disclosed herein. The survey manager 101 comprises of a controller 201, a trigger module 202, an aggregator 203, an interface 204, a mapping module 205, a report generation module 206, a development module 207 and an effectiveness tracking module 208. The interface 204 comprises of a means for enabling the administrator 103 to connect to the survey manager 101 and administer the survey. The interface 204 may enable the administrator 103 to change triggers, the statements, information related to the employees and so on. The interface 204 may enable the administrator to manually make the statements available to the employees. The interface 204 further enables at least one employee 102 to take survey, which may be triggered by the survey manager 101. The interface 204 may enable the employee 102 to view reports associated with survey taken by the employee 102. The interface 204 may enable the employee to view survey and associated reports of at least one other employee, provided the employee has the requisite permissions to view them. The interface 204 may comprise of a user interface to enable the administrator 103 and/or employee 102 to interact with the survey manager 101. The interface may also comprise of at least one physical connection means such as a wireless connection means (such as Wi-Fi and so on), a wired connection means (such as an Ethernet cable, USB (Universal Serial Bus) cable and so on).

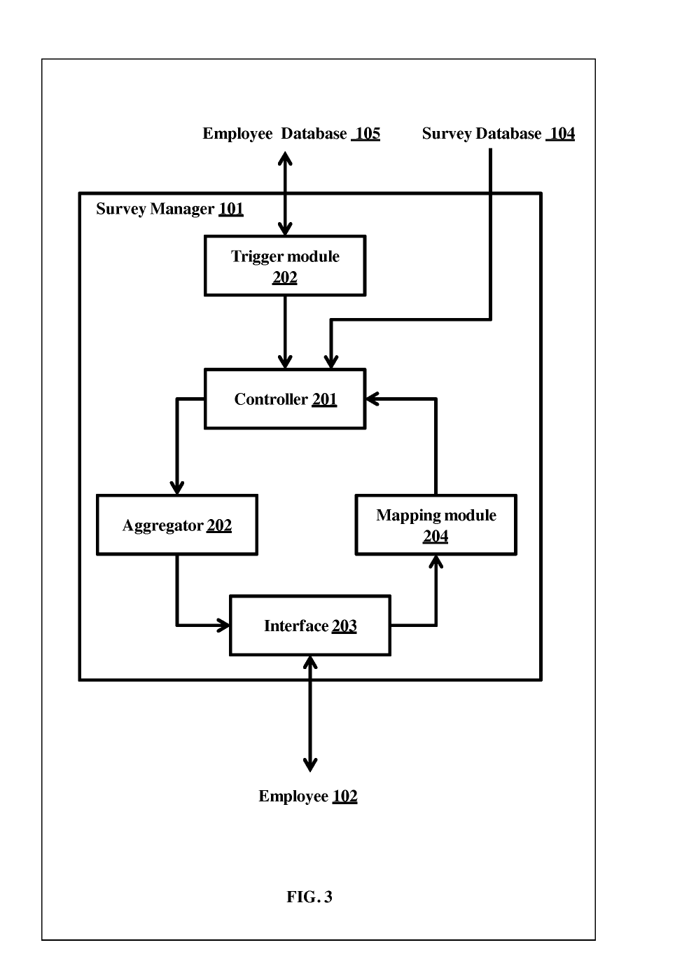

The trigger module 202 may be configured to monitor triggers related to at least one statement (as depicted in FIG. 3). The triggers may be time based (every 3 months for each employee, every 12 months for each employee and so on), event based (such as the employee leaving a project/assignment for a new project/assignment) or a combination of time and event based (such as within 45 days of an employee leaving an assignment, 30 days of an employee changing his location (such as office, city and so on) and so on). The trigger module 202 may also enable an administrator 202 or an authorized person to trigger a statement for an employee or a group of employees. On detecting a trigger for at least one statement being triggered, the trigger module 202 sends an indication to the controller 201(as depicted in FIG. 3). The indication may comprise of a pointer to the statement(s) being triggered.

The controller 201, on receiving the indication from the trigger module 202, fetches the statement(s) from the survey database 104 (as depicted in FIG. 3). The controller 201 may check if an employee has been previously completed the survey within a pre-defined time limit, before sending the survey to the employee. The controller 201 sends the fetched statements to the aggregator 203 (as depicted in FIG. 3). The aggregator 203 checks the statement(s) for any similar questions. The aggregator 203 may use semantics based analysis for checking for similar questions. The aggregator 203 may use prior experimental data and/or indications received from the administrator 103 to determine the similar questions. The aggregator 203 may use identify and group questions with a similar underlying construct using responses from experimental/pilot surveys using semantics based analysis methods. Once grouped, the aggregator 203 selects the questions with the highest correlation coefficient to represent the group. Subsequently, the aggregator 203 maps the other questions back to the chosen questions (which become the final user end question). The aggregator 203 may further store the information related to the similar questions and the removed questions in a suitable location such as the survey database 104, another database accessible to the survey manager 101, a memory internal to the survey manager 101, a memory external to the survey manager 101 and accessible to the survey manager 101. The aggregator 203 may further present the survey to the employee 102 through the interface 204 (as depicted in FIG. 3).

The controller 201 may enable a timer for a pre-defined period of time on presenting the survey to the employee 102, wherein the employee 102 has to complete the survey within the pre-defined period of time. The pre-defined period of time may be defined by the administrator 103. If the employee does not complete the survey in the pre-defined period of time, the controller 201 may raise an alert to the administrator 103 and/or at least one other employee mapped to the target employee through a pre-defined logic (eg. HR partner).

On receiving the completed survey from the employee (as depicted in FIG. 3), the mapping module 205 may check for any similar questions which were present initially in the statement(s). The mapping module 205 may use the information stored by the aggregator 203. The mapping module 205 on discovering at least one similar question, may map the response of the employee to the question to the other similar questions present in the statement(s). The mapping module 205 may perform mapping using a multiplying factor that are assigned to each question (wherein the multiplying factor may be assigned by the administrator), wherein the mapping module 205 may determine a rating of the mapped questions as

rating of the mapped question=response of the final question×multiplying factor

The mapping module 205 further may send the completed survey with the mapped results to the controller 201 (as depicted in FIG. 3).

The controller 201 may store the completed survey(s) in a suitable location such as the survey database 104, the employee database 105, another database accessible to the survey manager 101, a memory internal to the survey manager 101, a memory external to the survey manager 101 and accessible to the survey manager 101. The controller 201 further sends the completed survey(s) to the report generation module 206. The controller 201 may send the completed survey(s) to the report generation module 206, on receiving the completed survey(s). The controller 201 may send the completed survey(s) to the report generation module 206, on receiving a request from the employee, the administrator 103 or any other employee authorized to view report for the employee.

The report generation module 206 prepares at least one report based on the completed survey. The report generation module 206 may generate a report highlighting the main areas of interest of the employee, the extent to which these areas are being leveraged in terms of the employee and so on. The report generation module 206 may further generate a feedback report based on the survey completed by other employees which may comprise of questions pertaining to the employee. The feedback report may comprise of strengths of the employee, potential weaknesses of the employee, areas where the employee requires development as perceived by other employees and so on. The report generation module 206 may further generate a rater pattern report, which may highlight the level of maturity exhibited as a rater by the employee; that is the level of differentiation exhibited when rating employees on the strengths and blind spots and differentiating between employees. The report generation module 206 may further provide a report on how employees perceive the work environment in the organization based on logics of mean, standard deviations and percentiles, wherein this report may be provided to key stakeholders/process owners.

Based on the completed survey(s) and the reports generated by the report generation module 206, the development planning module 207 enables the employees to work on their strengths/weaknesses and development areas in a structured and systematic manner. The development planning module 207 may provide a plurality of materials to the employee, such as guidebooks, work books, online course material, audiovisual materials and so on. The materials may be located internal to the survey manager 101 in a memory. The materials may also be located external to the survey manager in a suitable location such as a database, an external memory, the cloud, internet and so on. The development planning module 207 may trigger a survey for the employee on the employee completing a pre-defined set of materials. The development module picks from the ‘hall of fame’- platform for shared learning & experiences, the “stuff that works” and based on a mapping logic of similar role/competency to the individual in question, brings forth an output of what has worked for others.

Based on the completed survey(s) and the reports generated by the report generation module 206, the effectiveness tracking module 208 enables the employees to plan and execute interventions for other employees to maintain their interests.

The controller 201 may use the responses by employees to the surveys, to infer by means of a pre-defined logic which statements are of particular importance to employees and which statements are not of particular importance to the employees. The controller 201 may use the pre-defined logic of mean and standard deviation. In time the statement manager 101 may be able to infer through the “wisdom of the crowd” which surveys/questions to modify.

The controller 201 may use a combination of mean and standard deviation scores against each statement to identify where the organization stands in terms of the Overall Quality of Experience (which relates to the mean score) and Overall Consistency of Experience (which relates to Standard Deviation). The controller 201 has defined thresholds for mean and standard deviations. However the controller 201 based on new data; adjust these thresholds intelligently to focus action planning on the vital few and adjust for change in calibration levels of new workforce that is responding to the survey item. Hence the controller functions like a “learning system”.

The controller 201 may auto-close the statement once sampling adequacy is met (when a statistically significant number of participation is achieved). The controller 201 may intrinsically calculate the sampling adequacy based on a plurality of factors such as total sample size, confidence percentages and so on.

The controller 201 enables performance of a role based survey, wherein the survey is role specific and may provide a 360 degree feedback. The controller 201 may map each employee to a particular job role that he/she is performing in the organization. Depending on the role an employee is mapped to, the controller 201 provides feedback to the employees. The feedback may comprise of top three competencies and the associated elements most critical to the job role performed by the employees. These elements are visualized in the job context of the respondent as specific behaviors that are posed as survey items. In a similar manner the role specific survey, reports and post survey development actions may also be role specific.

The controller 201 may perform role and passion driver analysis to increase role efficacy. The controller 201 may measure the sources of passion for an employee and the extent to which this passion is being leveraged in the organization. The passion analysis may be used to increase role alignment. In an example, if for a work manager role, it is seen that innovation is a high passion driver, then practices are adopted to such roles to highly innovation based tasks.

The controller 201 may provide post surveying employees and key stakeholders patterned reports which are pre-generated. Examples of such reports are 360 Degree Feedback Report, Passion Report, Ratter Pattern report (that analyses the rating tendencies exhibited by employees) and so on.

The controller 201 may use social platforms where employees are able to share best practices and experiences (wherein the social platforms may be internal platforms belonging to the organization). The controller 201 may extract information from the social platforms such as the expertise of the employees, the courses/trainings taken by the employee and so on. The controller 201 may use this information to create a development map for employees to improve on common competencies, wherein the development maps may be made available to all employees to access and follow. Also the module provides employee partners “stuff that works” for action planning for the whole unit.

The controller 201 may cater to the development of not only the person giving feedback, but also those who give feedback (as in 360 Degree Feedback). The controller 201 may enable providing additional material to the employees based on the number of feedbacks given, wherein the additional material may comprise of work-books, guidebooks on communication, team building, motivation, time management and daily planners.

The controller 201 may enable employees to view in real time whether they have received enough feedback and where they stand with regard to their peers with respect to the number of feedback given/received. The controller 201 may also enable the employees to view in real time their standing in percentile terms with regard to their role peers on particular competencies based on number of feedbacks received till that point. The controller 201 may enable automatic alteration of thresholds based on past response patterns to focus on relevant responses.

In the case of 360 Degree Feedback, the controller 201 may keep the completed surveys confidential and anonymous. The controller 201 may encrypt the completed surveys and only an aggregate of relevant responses in the completed surveys by all employees is shown. The employees who give the feedback to a manager (for instance) will be able to view an abridged version of the report by default. The manager has the option of the making his/her report public, wherein the entire organization can view the same.

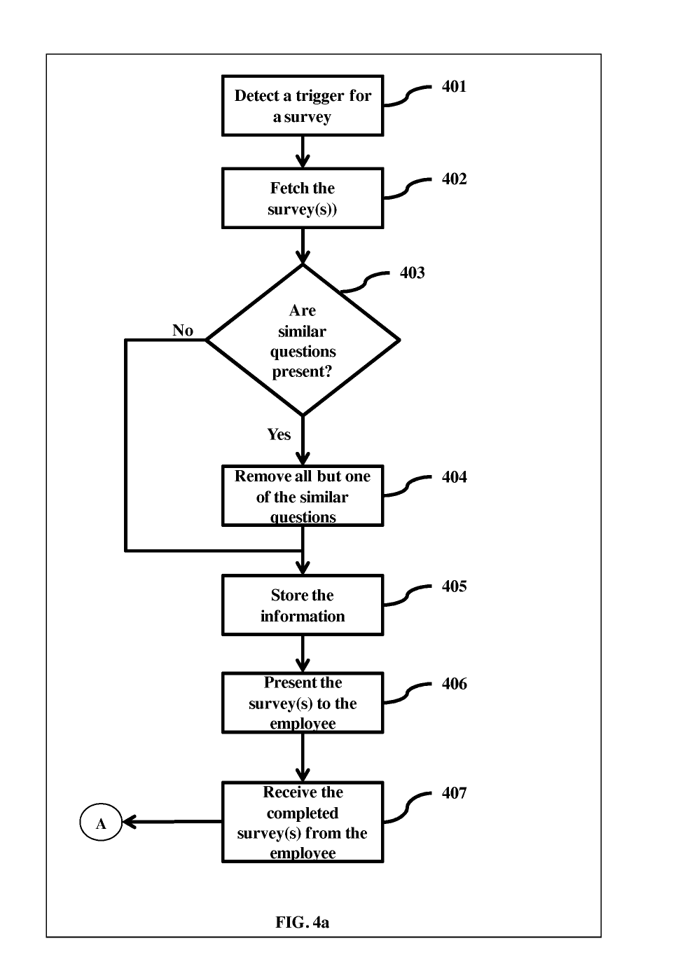

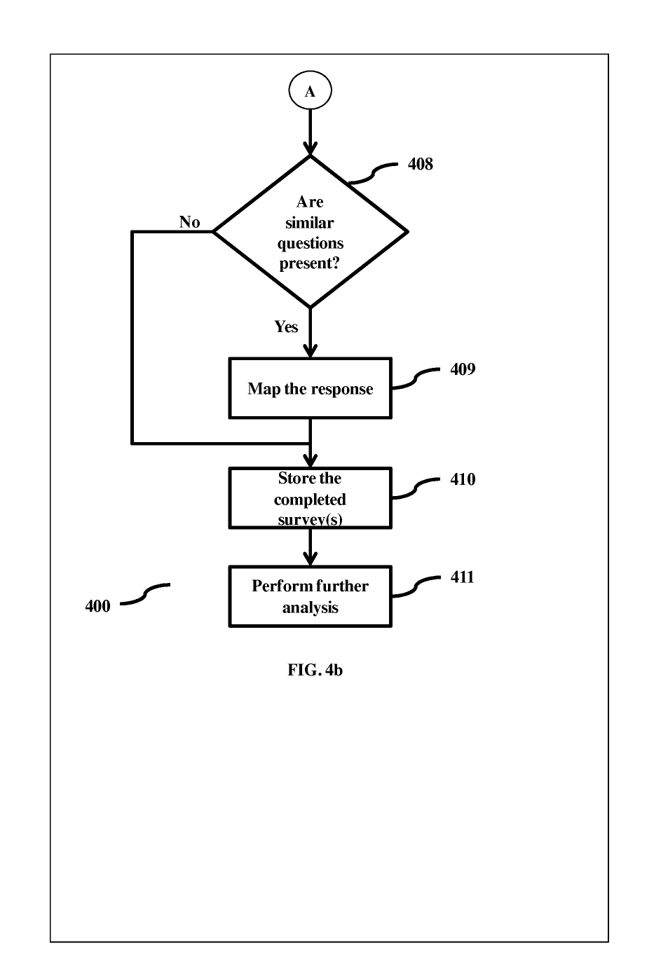

FIGS. 4a and 4b are flowcharts illustrating the process of performing survey in an organization, according to embodiments as disclosed herein. On detecting (401) a trigger for at least one survey being triggered, the survey manager 101 fetches (402) the survey(s) from the survey database 104. The survey manager 101 checks (403) the survey(s) for any similar questions. The aggregator 203 may use semantics based analysis for checking for similar questions. The aggregator 203 may use prior experimental data and/or indications received from the administrator 103 to determine the similar questions. If the survey manager 101 finds at least one set of similar questions, the survey manager 101 removes (404) all but one of the similar questions from the survey(s). The survey manager 101 further stores (405) the information related to the similar questions and the removed questions in a suitable location. The survey manager 101 further presents (406) the survey to the employee 102. On receiving (407) the completed survey from the employee, the survey manager 101 checks (408) for any similar questions which were present initially in the survey (s), but were removed previously. The mapping module 205 may use the information stored previously. If the survey manager 101 discovers at least one similar question, the survey manager 101 maps (409) the response of the employee to the question to the other similar questions present in the survey(s). The survey manager 101 stores (410) the completed survey(s) in a suitable location. The controller 201 further performs (411) further analysis on the completed survey(s) to generate reports and associated planning and tracking. The various actions in method 400 may be performed in the order presented, in a different order or simultaneously. Further, in some embodiments, some actions listed in FIGS. 4a and 4b may be omitted.

Embodiments disclosed herein enables a reduction in the number of statements polled to an employee annually thereby decreasing fatigue while increasing the quantity of output and saves the duplication of time and resources incurred in executing multiple survey.

Embodiments disclosed herein enable multiple inter-tool linkages, which enable a holistic snapshot of the organization through integrated reports and dashboards, a vital tool for human resources and senior leadership in decision making.

Embodiments herein disclose use of a trigger mechanism which permits for capturing feedback at the instance when the employee completes a significant event in his/her life cycle.

Embodiments herein enable a one stop destination for employees to give and receive feedback.

Embodiments disclosed herein enable integration of a plurality of statements tools and databases under a single platform, wherein linkages may exist between the pluralities of tools. The linkages between the tools enable the plurality of tools to interact with each other, hereby providing a holistic view of the organization/individual.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

What is claimed is:

1. A method for performing automated surveys in an organization, the method comprising of
fetching at least one survey by a survey manager;
checking for at least one similar question among the at least one survey by the survey manager;
removing all but one of the similar questions from the at least one survey by the survey manager, on the survey manager detecting at least one similar question among the at least one survey;
storing information related to the similar questions by the survey manager;
presenting the at least one survey to an employee by the survey manager;
checking for at least one similar question which was previously removed in at least one completed survey by the survey manager, on the survey manager receiving the at least one completed survey from the employee; and
mapping response to the at least one similar question to the other similar questions by the survey manager based on the stored information, on the survey manager detecting at least one similar question which was previously removed in the at least one survey.

2. The method, as claimed in claim 1, wherein the method further comprises of the survey manager fetching the at least one survey on the survey manager detecting a trigger for the at least one survey.

3. The method, as claimed in claim 2, wherein the trigger comprises of at least one of a date based trigger; and an event based trigger.

4. The method, as claimed in claim 1, wherein the method further comprises of the survey manager fetching the at least one survey on receiving an instruction from an administrator.

5. The method, as claimed in claim 1, wherein the method of checking for similar questions further comprises of
grouping questions with a similar underlying construct by the survey manager, wherein the survey manager checks for the similar underlying construct based on at least one of semantics based analysis; prior experimental data; and indications received from the administrator;
selecting a question from the group with highest correlation coefficient by the survey manager, wherein the selected question represents the group; and
mapping questions which are not selected to the selected question by the survey manager, wherein the selected question is present in the at least one survey sent to the employee.

6. The method, as claimed in claim 1, wherein mapping the response to the at least one similar question to the other similar questions comprises of determining a rating for the mapped question as
rating of the mapped question=response of the final question×multiplying factor.
wherein the multiplying factor is assigned to each question.

7. The method, as claimed in claim 1, wherein the method further comprises of the survey manager storing the at least one completed survey with the mapped response.

8. The method, as claimed in claim 1, wherein the method further comprises of the survey manager generating a report based on the at least one completed survey with the mapped response.

9. The method, as claimed in claim 8, wherein the report is at least one of a feedback report; a rater pattern report; a passion report and a report on how the employee perceives the work environment in the organization.

10. The method, as claimed in claim 1, wherein the method further comprises of the survey manager making the at least one completed survey available to at least one other employee, if the at least one other employee has the permissions required to view the at least one survey.

11. The method, as claimed in claim 1, wherein the method further comprises of the survey manager enabling the employee to work on strengths/weaknesses and development areas in a structured and systematic manner, wherein the survey manager provides at least one of guidebooks, work books, online course material, audiovisual materials to the employee.

12. The method, as claimed in claim 1, wherein the method further comprises of enabling employees to plan and execute interventions for other employees to maintain their interests.

13. The method, as claimed in claim 1, wherein the method further comprises of the survey manager modifying the at least one survey based on the response to the at least one survey from more than one employee.

14. The method, as claimed in claim 1, wherein the method further comprises of the survey manager determining Overall Quality of Experience of the organization.

15. The method, as claimed in claim 14, wherein the method further comprises of the survey manager determining Overall Quality of Experience of the organization using mean score.

16. The method, as claimed in claim 1, wherein the method further comprises of the survey manager determining Overall Consistency of Experience of the organization.

17. The method, as claimed in claim 16, wherein the method further comprises of the survey manager determining Overall Consistency of Experience of the organization using standard deviation.

18. The method, as claimed in claim 1, wherein the method further comprises of the survey manager performing a 360 degree feedback using a role based survey, wherein an aggregate of relevant responses in the at least one completed survey is used.

19. The method, as claimed in claim 1, wherein the method further comprises of the survey manager performing role and passion driver analysis.

20. The method, as claimed in claim 1, wherein the method further comprises of
extracting information about an employee from at least one social platform by the survey manager; and
creating a development map for the employee by the survey manager based on the extracted information and at least one completed survey.

21. The method, as claimed in claim 1, wherein the method further comprises of the survey manager enabling the employee to view in real time whether the employee has received enough feedback and where the employee stands with regard to their peers with respect to the number of feedback given/received.

22. The method, as claimed in claim 1, wherein the method further comprises of the survey manager enabling the employee to view in real time the standing of the employee in percentile terms with regard to the role peers of the employee on particular competencies based on number of feedbacks received till that point.

23. The method, as claimed in claim 1, wherein the survey manager encrypts the at least one completed survey.

24. A system for performing automated surveys in an organization, the system configured for
fetching at least one survey;
checking for at least one similar question among the at least one survey;
removing all but one of the similar questions from the at least one survey, on detecting at least one similar question among the at least one survey;
storing information related to the similar questions;
presenting the at least one survey to an employee;
checking for at least one similar question which was previously removed in at least one completed survey, on receiving the at least one completed survey from the employee; and
mapping response to the at least one similar question to the other similar questions based on the stored information, on detecting at least one similar question which was previously removed in the at least one survey.

25. The system, as claimed in claim 24, wherein the system is configured for fetching the at least one survey on detecting a trigger for the at least one survey.

26. The system, as claimed in claim 25, wherein the trigger comprises of at least one of a date based trigger; and an event based trigger.

27. The system, as claimed in claim 24, wherein the system is configured for fetching the at least one survey on receiving an instruction from an administrator.

28. The system, as claimed in claim 24, wherein the system is configured for checking for similar questions by
grouping questions with a similar underlying construct, wherein the system checks for the similar underlying construct based on at least one of semantics based analysis; prior experimental data; and indications received from the administrator;
selecting a question from the group with highest correlation coefficient, wherein the selected question represents the group; and
mapping questions which are not selected to the selected question, wherein the selected question is present in the at least one survey sent to the employee.

29. The system, as claimed in claim 24, wherein the system is configured to map the response to the at least one similar question to the other similar questions by determining a rating for the mapped question as
rating of the mapped question=response of the final question×multiplying factor.
wherein the multiplying factor is assigned to each question.

30. The system, as claimed in claim 24, wherein the system is configured for storing the at least one completed survey with the mapped response.

31. The system, as claimed in claim 24, wherein the system is configured for generating a report based on the at least one completed survey with the mapped response.

32. The system, as claimed in claim 31, wherein the report is at least one of a feedback report; a rater pattern report; a passion report and a report on how the employee perceives the work environment in the organization.

33. The system, as claimed in claim 24, wherein the system is configured for making the at least one completed survey available to at least one other employee, if the at least one other employee has the permissions required to view the at least one survey.

34. The system, as claimed in claim 24, wherein the system is configured for enabling the employee to work on strengths/weaknesses and development areas in a structured and systematic manner, wherein the system provides at least one of guidebooks, work books, online course material, audiovisual materials to the employee.

35. The system, as claimed in claim 24, wherein the system is configured for enabling employees to plan and execute interventions for other employees to maintain their interests.

36. The system, as claimed in claim 24, wherein the system is configured for modifying the at least one survey based on the response to the at least one survey from more than one employee.

37. The system, as claimed in claim 24, wherein the system is configured for determining Overall Quality of Experience of the organization.

38. The system, as claimed in claim 37, wherein the system is configured for determining Overall Quality of Experience of the organization using mean score.

39. The system, as claimed in claim 24, wherein the system is configured for determining Overall Consistency of Experience of the organization.

40. The system, as claimed in claim 39, wherein the system is configured for determining Overall Consistency of Experience of the organization using standard deviation.

41. The system, as claimed in claim 24, wherein the system is configured for performing a 360 degree feedback using a role based survey, wherein an aggregate of relevant responses in the at least one completed survey is used.

42. The system, as claimed in claim 24, wherein the system is configured for performing role and passion driver analysis.

43. The system, as claimed in claim 24, wherein the system is configured for
extracting information about an employee from at least one social platform; and
creating a development map for the employee based on the extracted information and at least one completed survey. It also aggregates “stuff that works” based on a mapping logic of similar role/competency to the individual in question and brings forth an output of what has worked for others.

44. The system, as claimed in claim 24, wherein the system is configured for enabling the employee to view in real time whether the employee has received enough feedback and where the employee stands with regard to their peers with respect to the number of feedback given/received.

45. The system, as claimed in claim 24, wherein the system is configured for enabling the employee to view in real time the standing of the employee in percentile terms with regard to the role peers of the employee on particular competencies based on number of feedbacks received till that point.

46. The system, as claimed in claim 24, wherein the system is configured for encrypting the at least one completed survey.
